(19) United States
(12) Patent Application Publication
(10) Pub. No.: US 2023/0086116 A1
(43) Pub. Date: Mar. 23, 2023

(54) Brake Caliper Device, Disc Brake Assembly, Use of a Brake Caliper Device and Method for Radially Retaining Air

(71) Applicant: MANN+HUMMEL GmbH, Ludwigsburg (DE)

(72) Inventor: Benedikt WELLER, Steinheim (DE)

(21) Appl. No.: 18/070,468

(22) Filed: Nov. 29, 2022

Related U.S. Application Data
(63) Continuation of application No. PCT/EP2021/064594, filed on Jun. 1, 2021.

(30) Foreign Application Priority Data
Jun. 2, 2020 (DE) 102020114659.0

(51) Int. Cl. F16D 65/00; F16D 55/226; B60T 1/06

(52) U.S. Cl. CPC F16D 65/0031; F16D 65/0075; F16D 65/0056; F16D 55/226; B60T 1/065; F16D 2055/002

(57) ABSTRACT

A brake caliper device for a disc brake assembly with a brake disc has a brake caliper support to be arranged stationarily relative to a vehicle. A brake caliper for holding at least one brake pad is provided, wherein the brake caliper can slide relative to the brake caliper support in an axial direction. A seal device is provided that seals a gap formed between the brake caliper and the brake caliper support. The seal device extends in the axial direction. The seal device has a brush, a sealing lip, and/or a loose sealing material projecting away from the brake caliper support in a direction toward the oppositely positioned brake caliper and/or projecting away from the brake caliper in a direction toward the oppositely positioned brake caliper support.

### CROSS-REFERENCE TO RELATED APPLICATIONS

This application is a continuation application of International Application No. PCT/EP2021/064594 filed on Jun. 1, 2021, which claims the benefit of German Application No. 10 2020 114 659.0 filed on Jun. 2, 2020, the entire disclosures of which are incorporated herein by reference for all purposes.

### BACKGROUND

Embodiments concern a brake caliper device for a disc brake assembly, in particular for a motor vehicle. Furthermore, such a disc brake assembly is proposed. Furthermore, a system with such a disc brake assembly as well as the use of a brake caliper device and a method for radial retention of air with the brake caliper device are proposed.

In a braking process, particles can be produced by abrasion at a brake disc and/or at brake pads. In order to retain these particles, for example, a brake dust particle filter is used which is arranged in a forward rotation direction downstream of a brake caliper device. Such a brake dust particle filter is known, for example, from WO 2019/048374 A1.

### SUMMARY

It is an object of the embodiments to provide improved measures for reduction of brake dust emissions at disc brake assemblies.

According to a first aspect, a brake caliper device for a disc brake assembly with a brake disc is therefore proposed, wherein the brake caliper device comprises:

a brake caliper support stationary relative to a vehicle;

a brake caliper for holding at least one brake pad, wherein the brake caliper is slidable relative to the brake caliper support in axial direction; and

a seal device for sealing a gap between the brake caliper and the brake caliper support, wherein the seal device extends in axial direction.

“Axial” is to be understood as a direction which extends parallel to an axis of rotation of the brake disc of the disc brake assembly.

By means of the seal device, sealing of the brake caliper in relation to the brake caliper support can be realized. In this way, it is in particular prevented that particles, which are produced by abrasion at a brake disc and/or at brake pads, escape from the disc brake assembly through the gap between the brake caliper and the brake caliper support. In particular, a radial escape of the particles is reduced and/or prevented. Because the particles are retained in the disc brake assembly, a larger quantity of particles can be guided into a brake dust particle filter, which is arranged downstream of the disc brake assembly in forward travel direction, and separated thereat. In this way, a reduction of brake dust emissions at the disc brake assembly can be achieved.

The brake caliper device comprises in particular the brake caliper support which, in the mounted state, is fastened stationarily at the vehicle or at a vehicle wheel as well as the brake caliper which is floatingly supported at the brake caliper support. This floating support enables an axial movement of the brake caliper relative to the brake caliper support and thus to the vehicle. The floating support is achieved in particular by pistons or pins which movably hold the brake caliper at the brake caliper support.

During a braking process, brake fluid is pressurized and pushes the brake pad of the brake caliper against the brake disc with the aid of a piston of the brake caliper. In this way, a rotation of the brake disc can be stopped.

In the mounted state, the brake caliper support can “frame” the brake caliper. In order to enable in such a case a relative movement between the brake caliper and the brake caliper support, in particular a gap between the brake caliper and the brake caliper support is provided. The gap extends in particular along a circumferential direction of the brake disc. Without suitable sealing, air and brake dust particles produced during braking can escape radially from the gap.

The seal device serves in particular to prevent this radial escape. For this purpose, the seal device can seal the gap at least partially and retain at least a portion of the brake dust particles in the disc brake assembly. The seal device is provided in this context preferably such that it does not impair the relative movement of the brake caliper in relation to the brake caliper support. This means that the brake caliper remains axially slidable relative to the brake caliper support despite the seal device.

That the seal device extends in an axial direction means in particular that it completely seals the gap in axial direction.

The brake caliper device is suitable for arbitrary applications in disc brakes. In this context, the brake caliper device can be used for stationary or mobile applications. As mobile applications, for example, motor vehicles such as passenger cars, trucks, buses, rail vehicles or the like are conceivable. Stationary, shaft brakes as they are used in wind or water power facilities can be furnished with corresponding brake caliper devices.

According to an embodiment, the brake caliper support comprises:

at least two fastening sections for connection of the brake caliper support at the vehicle side to a steering knuckle of the vehicle; and

a holding section extending from the fastening sections in axial direction which, in the mounted state, at least partially surrounds the brake disc and comprises a receiving region for the brake caliper.

Moreover, the brake caliper comprises:

two brake caliper legs for attachment of a brake pad, respectively; and

a brake caliper body which connects the brake caliper legs to each other and, in the mounted state, at least partially surrounds the brake disc;

wherein the gap which is sealed by the seal device is a gap between the holding section and the brake caliper body.

The fastening sections of the brake caliper support serve in particular to fasten the brake caliper support stationarily at the vehicle. The fastening sections are in particular receiving sections for fastening screws.

The holding section is in particular a part of the brake caliper support which extends axially and, in this context, at least partially spans across or bridges a circumference of the brake disc. The brake caliper support can also comprise a leading and a rear holding section, wherein the rear holding section is arranged downstream of the leading one in rotation direction.

The brake caliper comprises in particular the brake caliper body which connects the two brake caliper legs to each other and in this context at least partially spans across the circumference of the brake disc. The brake caliper legs are in particular the parts of the brake caliper to which the brake pads are fastened. The brake caliper legs extend, for example, parallel to the brake disc or along a radial direction.

In the mounted state, the seal device is provided in particular at a side of the brake caliper device which borders the brake dust particle filter. The seal device seals in this context, for example, a gap between the leading holding section and the brake caliper body.

According to a further embodiment, the seal device is configured to reduce a particle escape in a direction which is radial in relation to a rotation direction of the brake disc in a mounted state.

It is in particular prevented that the particles escape radially from the brake caliper device and/or the disc brake assembly. The particles are caught, for example, in a region between the brake caliper device and the brake disc and can escape only in a circumferential direction from the region. Since the brake dust particle filter is arranged in circumferential direction downstream of the brake caliper device, the particles can thus be guided in particular in a targeted fashion into the brake dust particle filter and can be filtered out thereat.

According to a further embodiment, the seal device is formed as one piece together with the brake caliper and/or the brake caliper support. The seal device can be part of the brake caliper and/or of the brake caliper support, which is in particular advantageous because the seal device can be produced in a single manufacturing process together with the brake caliper and/or the brake caliper support. In this way, the seal device is produced with minimal expenditure.

The brake caliper and/or the brake caliper support comprise in particular aluminum, steel and/or cast iron. In a one-piece (or one-part) seal device, the latter can be manufactured of the same materials as the brake caliper and/or the brake caliper support.

According to a further embodiment, the seal device is formed of a caliper seal part of the brake caliper and an oppositely positioned support seal part of the brake caliper support.

The seal device can be of a two-part configuration, wherein a caliper seal part belongs to the brake caliper and a support seal part belongs to the brake caliper support.

In particular, between the caliper seal part and the support seal part a distance (as small as possible) is provided in order to enable the relative movement between the brake caliper and the brake caliper support.

According to a further embodiment, the seal device is formed in that the caliper seal part and the support seal part are arranged displaced relative to each other in radial direction and at least partially overlap in circumferential direction.

The sealing function of the seal device can be achieved in that the caliper seal part and the support seal part in the region of the gap overlap and thus completely cover the gap in radial direction. The caliper seal part and the support seal part in particular do not contact each other in this context in order not to hinder the axial movability of the brake caliper.

According to a further embodiment, the caliper seal part and the support seal part have shapes which are complementary to each other and engage each other and together form a labyrinth seal with a plurality of deflections in the gap along the radial direction.

The caliper seal part and the support seal part engage each other in particular such that a radial escape of air and/or particles from the brake caliper device is made difficult because the gap comprises a plurality of deflections.

The brush, sealing lip and/or loose seal material can be present in this context at the caliper seal part or at the support seal part.

According to a further embodiment, the caliper seal part or the support seal part comprises a guide channel which extends along the axial direction, and the respective other one of the two parts comprises a projecting rib protruding into the guide channel, wherein in particular the brush, sealing lip and/or loose sealing material is present at the rib.

In case the caliper seal part comprises the guide channel, the support seal part in particular comprises the projecting rib. In case the support seal part comprises the guide channel, the caliper seal part in particular comprises the projecting rib. The projecting rib extends in particular along the axial direction. The guide channel and/or the rib can extend along the gap along the entire extension width of the brake caliper device.

According to a further embodiment,

the caliper seal part is embodied as one piece together with the brake caliper and/or the support seal part is embodied as one piece together with the brake caliper support; or

the caliper seal part is connected detachably to the brake caliper, in particular screwed on, glued on and/or welded on, and/or the support seal part is connected detachably to the brake caliper support, in particular screwed on, glued on and/or welded on.

Suitable materials for the brake caliper and/or the brake caliper support as well as for caliper seal part and/or support seal part embodied as one piece therewith comprise in particular aluminum, steel and/or cast iron. The one-piece configuration is advantageous in particular with respect to the manufacture because the manufacturing expenditure is reduced.

It is therefore advantageous to provide a detachable caliper seal part and/or support seal part because an existing brake caliper device can be retrofitted with an additional caliper seal part and/or support seal part in order to obtain the above explained advantages.

The seal device comprises a brush, sealing lip and/or loose sealing material which is projecting away from the brake caliper support in the direction toward the oppositely positioned brake caliper and/or away from the brake caliper in the direction toward the oppositely positioned brake caliper support.

The brush seal comprises, for example, a plurality of synthetic bristles which project away from the brake caliper support (or from the brake caliper) and with their loose ends are in contact with the oppositely positioned brake caliper (or with the oppositely positioned brake caliper support). The sealing lip can be made, for example, of plastic material, for example, an elastomer. However, it can be formed in particular also of a metallic material, in particular of a material of the brake caliper support and/or brake caliper, which is advantageous due to the good thermal resilience.

According to a second aspect, a disc brake assembly with a brake disc and a brake caliper device according to the first aspect or according to an embodiment of the first aspect is proposed, wherein the brake caliper holds at least one brake pad which can be pressed along the axial direction against the brake disc by movement of the brake caliper relative to the brake caliper support.

The embodiments and features described for the proposed brake caliper device apply likewise to the proposed disc brake assembly.

According to an embodiment, the seal device is configured to reduce a radial escape of brake dust-laden air flowing along the rotating brake disc from the brake caliper device.

The air which is flowing along the rotating brake disc is in particular air which is swirled up and rotates due to the rotation of the brake disc. This air comprises in particular the particles (brake dust particles) which are produced by abrasion at the brake disc and/or at the brake pad when braking.

In some embodiments, the brake disc is a vented brake disc which comprises openings for escape of air at its circumferential edge. In this case, the air which is flowing along the rotating brake disc is, for example, the air which is escaping from the openings of the vented brake disc.

According to a third aspect, a system is proposed which comprises a disc brake assembly according to the second aspect or according to an embodiment of the second aspect and a brake dust particle filter which is arranged downstream of the brake caliper device in a predetermined rotation direction of the brake disc, in particular the forward rotation direction.

The brake dust particle filter comprises, for example, an interior in which filter material is provided with which the brake dust particles are caught. With the aid of the brake dust particle filter, it can be prevented that brake dust particles escape to the exterior of the system so that a reduction of brake dust emissions is enabled. The brake dust particle filter can be arranged downstream of the brake caliper device such that the air which is flowing along the rotating brake disc flows from the brake caliper device in the direction toward the brake dust particle filter, in particular in direction toward the interior of the brake dust particle filter. The particles flow in particular without (or with only little) radial escape in a targeted fashion from the brake caliper device into the brake dust particle filter such that an efficient filtering of the particles is realized.

The embodiments and features described for the proposed brake caliper device and for the disc brake assembly apply likewise to the proposed system.

According to a fourth aspect, a use of the brake caliper device according to the first aspect or according to an embodiment of the first aspect is proposed, wherein the use serves for radially retaining brake dust-laden air flowing along the rotating brake disc in the brake caliper device.

The embodiments and features which have been described for the proposed brake caliper device and for the disc brake assembly apply likewise to the proposed use.

According to a fifth aspect, a method for radially retaining brake dust-laden air flowing along the rotating brake disc with the brake caliper device according to the first aspect or according to an embodiment of the first aspect is proposed, wherein the method comprises:

preventing, with the aid of the seal device, that the brake dust-laden air escapes radially from the brake caliper device.

The embodiments and features described for the proposed brake caliper device and for the disc brake assembly apply likewise to the proposed method.

According to an embodiment, the method comprises moreover:

introducing the brake dust-laden air into a brake dust particle filter which is arranged downstream of the brake caliper support in a predetermined rotation direction of the brake disc, in particular the forward rotation direction.

Further possible implementations of the embodiments comprise also combinations, not explicitly mentioned, of features or embodiments mentioned before or in the following in relation to the embodiment examples. In this context, a person of skill in the art will also add individual aspects as improvements or supplements to the respective basic form of the embodiments.

Further advantageous aspects of the embodiments are subject matter of the dependent claims as well as of the examples of the embodiments described in the following. In the following, the embodiments will be explained in more detail with reference to the attached Figures.

### BRIEF DESCRIPTION OF THE DRAWINGS

Further embodiments, features and advantages will become apparent from the subsequent description and dependent claims, taken in conjunction with the accompanying drawings.

FIG. 1 shows a perspective view of an embodiment of a system with a disc brake assembly and brake dust particle filter.

FIG. 2 shows a lateral plan view of the system according to FIG. 1.

FIG. 3 shows a section view of the system according to FIG. 1.

FIG. 4 shows a further section view of the system according to FIG. 1.

FIG. 5 shows a lateral plan view of an embodiment of a filter housing of a brake dust particle filter for a system according to FIGS. 1 to 4.

FIG. 6 shows a perspective view of the filter housing according to FIG. 5.

FIG. 7 shows a plan view of a brake caliper device.

FIG. 8 shows a lateral plan view of a disc brake assembly for the system according to FIGS. 1 to 4.

FIG. 9 shows a detail of the disc brake assembly according to FIG. 8.

FIG. 10 shows a section view of the disc brake assembly of FIG. 8 along A-A according to FIG. 7.

FIG. 11 shows a detail of the section view according to FIG. 10.

FIG. 12 shows an alternative embodiment of the seal device.

FIG. 13 shows a further alternative embodiment of the seal device.

### DETAILED DESCRIPTION

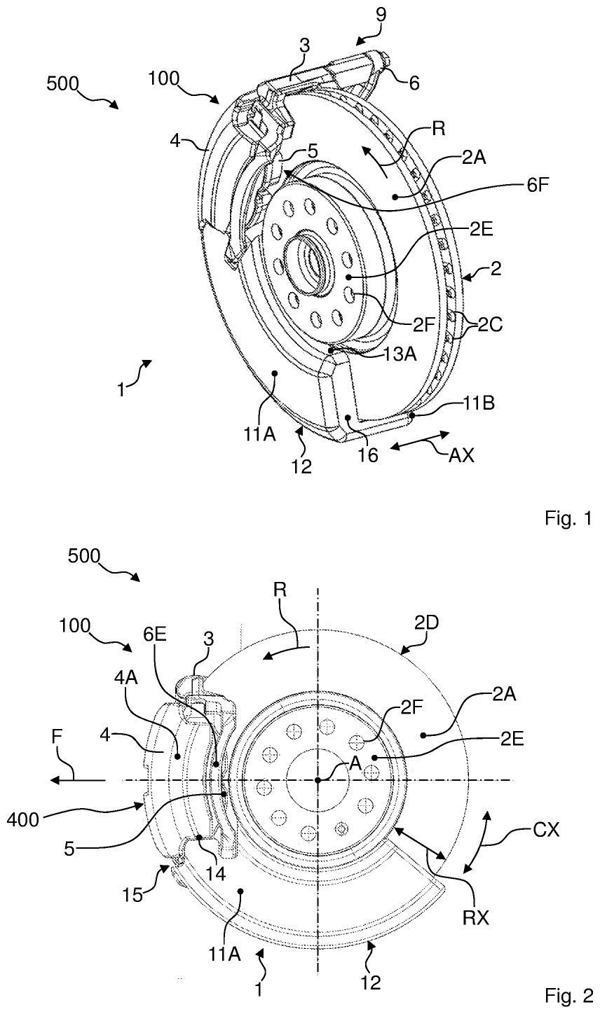

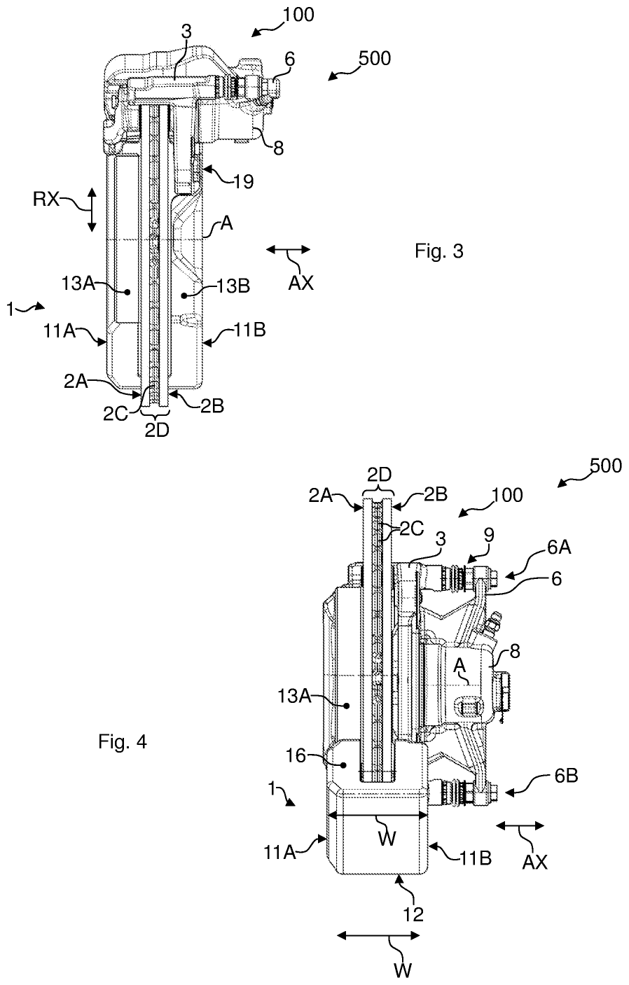

In FIGS. 1, 2, 3, and 4, different views of an embodiment of a system 500 with a disc brake assembly 100, for example, for a motor vehicle, and a brake particle filter 1 are illustrated. In this context, in FIG. 1 a perspective view of the system 100, in FIG. 2 a lateral view and in FIGS. 3 and 4 section views parallel to the axis of rotation A are illustrated.

The disc brake assembly 100 comprises a brake disc 2 which is furnished with inner venting in the illustrated embodiment. The brake disc 2 has a radially inwardly positioned fastening plate 2E which comprises fastening openings 2F. In the Figures, only one opening 2F is provided with a reference character. By means of the fastening plate 2E and the fastening openings 2F, the brake disc 2 is fastened by means of suitable fasteners such as, for example, wheel bolts, to the wheel suspension so that a rotationally fixed coupling with the vehicle wheel, not illustrated here, or the rims is produced. At the circumferentially extending brake disc edge 2D (compare FIG. 3), one can see radially outwardly oriented outflow openings 2C. Air for cooling the brake disc 2 flows from the outflow openings 2C in operation of the brake which rotates in rotation direction R. For simplification, in the following a braking process for a forward travel will be considered. In principle, the rotation direction can also be reversed.

In the Figures, a forward rotation direction R opposite to the clockwise direction is indicated. This is referred to in the following as forward rotation direction R. The axis of rotation A can be seen in FIGS. 2, 3, and 4. Due to the orientation of the brake disc 2, an axial extension direction AX (compare FIGS. 1, 3, and 4), a radial extension direction RX (compare FIG. 3), and a circumferential extension direction CX (compare FIG. 2) are provided.

In FIG. 2, substantially an installation situation of the brake disc 2 and of a brake caliper 4 engaging around the brake disc 2 is indicated. The brake caliper 4 is coupled to a brake caliper holder 3 which engages also around the brake disc 2. At the brake caliper 4, brake pads 5 are arranged on both sides of the brake disc 2 and can be pushed against the friction surfaces 2A, 2B by means of brake hydraulics 8 (compare FIGS. 3 and 4) during the braking process. The brake caliper 4 and the brake caliper holder 3 form together a brake caliper device 400.

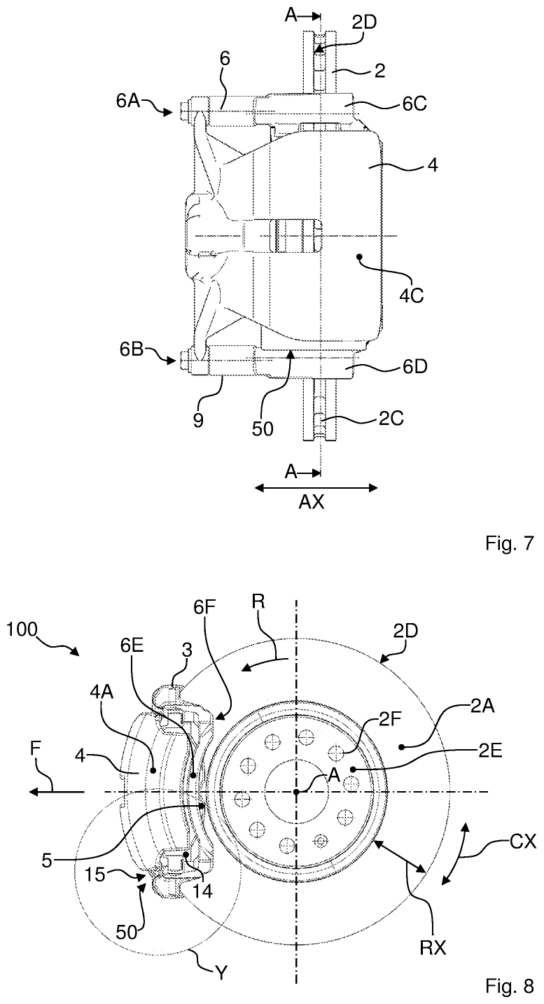

The brake caliper holder 3 as well as the brake caliper 4 are held by a floating support 9 by a brake caliper support 6. Due to the floating support 9, an automatic centering of the brake caliper 4 with the brake pads 5 in relation to the brake disc 2 is provided; the brake disc 2 is located between the gripping arms of the brake caliper 4 or the two brake pads 5. In the illustrated embodiment, the brake caliper 4 is arranged in forward travel direction F in front of the axis of rotation A. Variants are also conceivable in which the brake caliper 4 is provided behind the axis A. As illustrated in FIG. 7, the brake caliper 4 is held at the brake caliper support 6 so as to be slidable in axial direction AX. The brake caliper support 6 itself is stationarily fastened to a steering knuckle of the vehicle (not illustrated).

The brake caliper support 6 comprises two fastening sections 6A, 6B for vehicle-side connection of the brake caliper support 6 to the vehicle. The fastening sections 6A, 6B are located at an inner side of the vehicle. Two holding sections 6C, 6D extend away from the fastening sections 6A, 6B in axial direction and, in the mounted state, bridge the brake disc edge 2D at a distance, as illustrated in FIG. 7. The two holding sections 6C, 6D are connected to each other, in turn, by a connection arc 6E (FIG. 2). The holding sections 6C, 6D as well as the connection arc 6E define a receiving region 6F for the brake disc 2. The brake caliper support 6 engages around a region of the brake disc 2 substantially in a ring segment shape.

The brake caliper 4 comprises two brake caliper legs 4A for attachment of a brake pad 5, respectively. The brake caliper legs 4A extend substantially parallel to the brake disc 2. The brake disc 2 extends in this context between the two brake caliper legs 4A. The brake caliper legs 4A are connected to each other by a brake caliper body 4C (FIG. 7). The latter extends in axial direction AX and bridges in the mounted state the brake disc edge 2D. The brake caliper 4 engages about a region of the brake disc 2 substantially in a ring segment shape. The brake caliper support 6 forms in this context substantially a frame about the brake caliper 4.

A gap 15 is provided between the brake caliper 4 and the brake caliper support 6. It is required so that the brake caliper 4 is movable relative to the brake caliper support 6 in axial direction AX.

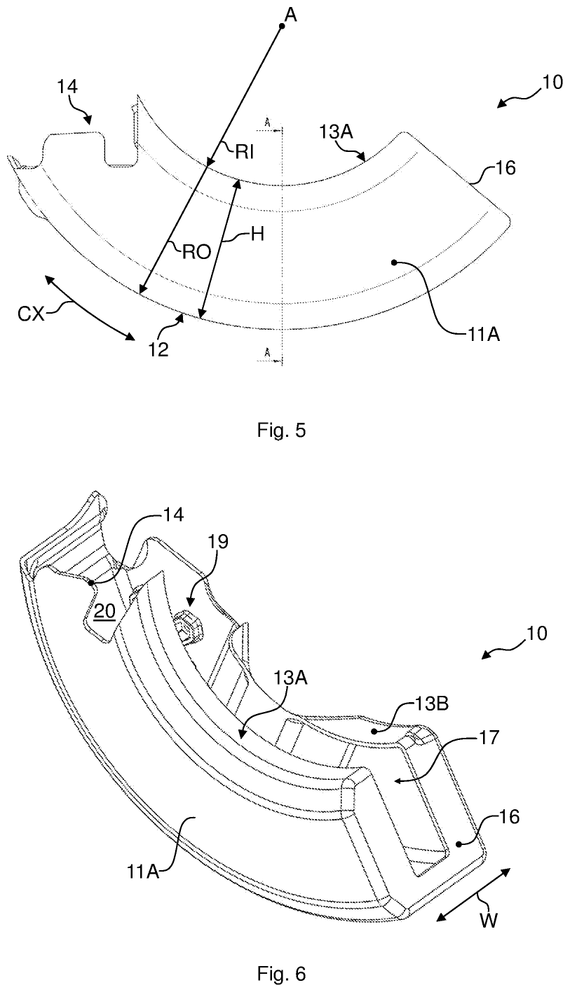

Since during the braking process the brake pads 5 are acting on the friction surfaces 2A, 2B of the brake disc 2, abrasion at the brake pads 5 and in principle also at the brake disc 2 is produced. A portion of these brake dust particles are entrained by the rotation R of the brake disc in circumferential direction CX. Therefore, for catching this brake dust or the brake dust particles, a brake dust particle filter 1 is provided downstream of the brake caliper 4 in rotation direction R. Detailed side views and perspective illustrations of the filter housing 10 of the brake dust particle filter 1 are represented in FIGS. 5 and 6.

The housing 10 of the brake dust particle filter 1 engages around a region of the brake disc 2 substantially in a ring segment shape. For this purpose, the brake dust particle filter 1 comprises a housing 10. The housing 10 has two oppositely positioned sidewalls 11A, 11B which are connected to each other by an outer circumferential wall 12 to an approximately U-shaped cross section. In the orientation of FIGS. 1, 3, and 4, an outer sidewall 11A is provided which in the mounted state is facing away from the vehicle. The oppositely positioned sidewall 11B (in the orientation of FIGS. 3 and 4 at the right side) is referred to as inner sidewall 11B because it is facing toward the vehicle interior. The brake disc 2 between the two sidewalls 11A, 11B is thus partially enclosed.

Inner circumferential wall sections 13A, 13B extend opposite the circumferential wall 12 in radial direction. The outwardly positioned, radially inwardly positioned and axially outwardly positioned circumferential wall section is identified by 13A. The radially inwardly positioned and axially inwardly positioned circumferential wall section is identified by 13B.

The housing edge 14 forms an opening of the filter housing 10 at the brake caliper side. The filter housing 10 extends in circumferential direction CX from the connection contour or an open side 14 of the housing 10 up to an end wall 16. The end wall 16 connects the outer sidewall 11A, the outer circumferential wall 12, and the inner sidewall 11B to each other. Between the inner circumferential wall sections 13A, 13B, an annular slot 17 is present into which the brake disc 2 can be inserted with its brake disc edge 2D. The housing walls 11A, 11B, 12, 13A, 13B, 16 enclose a housing interior 20. The brake disc 2 penetrates into the housing interior 20, or the filter housing 10 encloses or engages around a ring segment of the brake disc 2. The filter housing 10 or installed parts in the brake dust particle filter 1 do not contact the brake disc 2.

In FIG. 5, possible dimensions of the filter housing 10 are illustrated. FIG. 5 shows a side view from the exterior side of the disc brake assembly 100 in axial direction. One can see that the sidewalls, in particular the outer sidewall 11A visible in FIG. 5, has a ring segment shape. The filter housing 10, viewed from the axis of rotation A, is delimited radially inwardly by the inner circumferential wall sections 13A, 13B (not illustrated) and radially outwardly by the outer circumferential wall 12. In this context, an inner radius RI can result as the distance of the inner circumferential wall sections 13A, 13B and an outer radius RO as the distance of the circumferential wall 12 from the axis of rotation A. The difference of the radii RO−RI can be referred to as height H of the filter housing 10. The length of the filter housing results from the extension along the circumference between the open side 14 facing the brake caliper 4 and the end face 16. A width W of the filter housing 10 in its axial extension results from the distance between the two sidewalls 11A, 11B (compare FIGS. 4 and 6).

In operation of the disc brake assembly 100 and of the brake dust particle filter 1, an air flow in circumferential direction CX through the filter housing 10 along the rotation direction R of the brake disc 2 is produced by the rotation R of the brake disc 2.

In the interior 20 of the filter housing 10, the particles can deposit along the flow path in the filter housing 10 by adhesion forces at the inner walls or (not illustrated here) can be bonded by suitable filter materials.

The filter housing 10 or the brake dust particle filter 1 is fastened with a suitable fastener, for example, a screw, at the brake caliper holder 3. One can see fastener 19 in FIGS. 3 and 6.

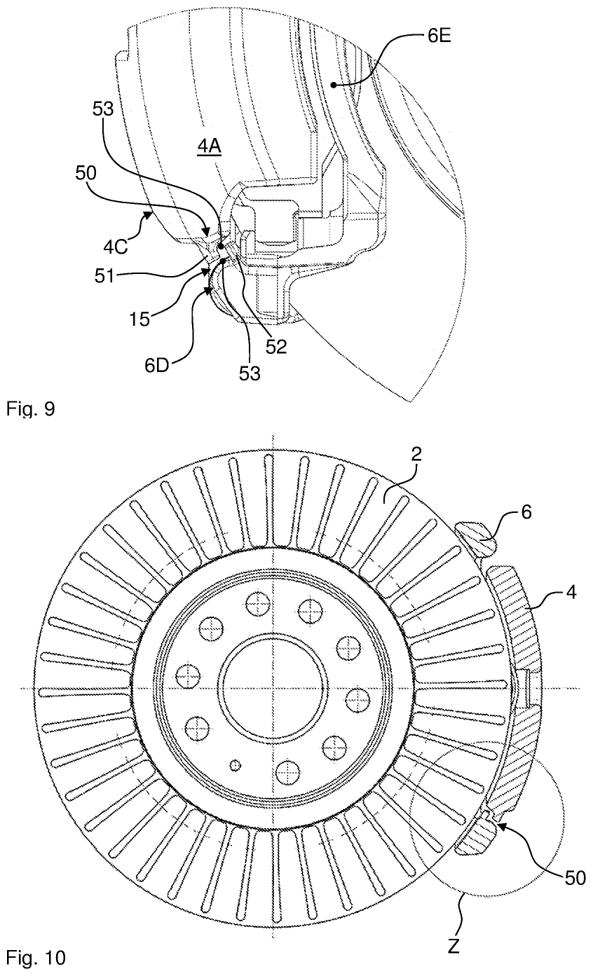

FIG. 8 shows a lateral plan view of a disc brake assembly 100 for the system 500 according to FIGS. 1-4. The illustration of FIG. 8 corresponds in this context to that of FIG. 2, wherein the brake dust particle filter 1 has been omitted. FIG. 9 shows a detail Y of the disc brake assembly 100 according to FIG. 8.

As can be seen in FIG. 9, a seal device 50 is provided in the region of the gap 15 between the brake caliper 4 and the brake caliper support 6. It enables a sealing action of the gap 15 in radial direction RX. The seal device 50 extends axially along the entire length of the gap 15. As illustrated in FIG. 7, the gap 15 is covered with the aid of the seal device 50 in radial direction RX.

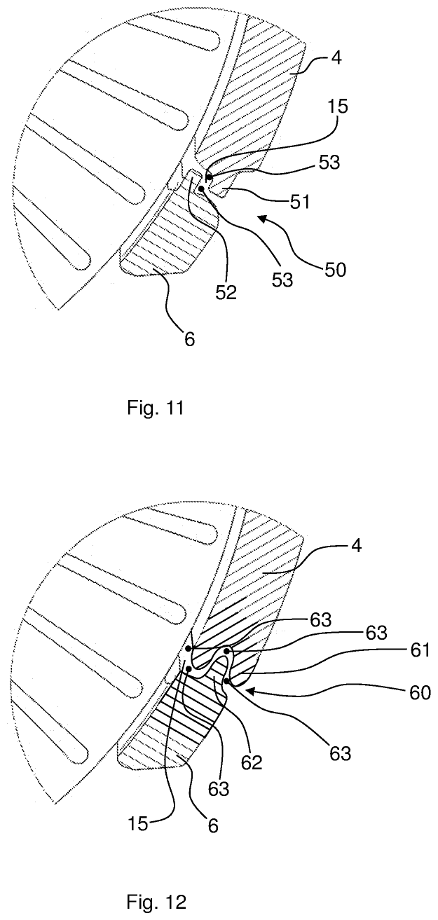

The contours of the seal device 50 can be seen particularly well in FIGS. 10 and 11. FIG. 10 shows a section view of the disc brake assembly of FIG. 8 along A-A according to FIG. 7, while in FIG. 11 a detail Z of the section view according to FIG. 10 is shown.

The seal device 50 is of a two-part configuration. It comprises a caliper seal part 51 which is formed as one part together with the brake caliper 4 and a support seal part 52 which is formed as one part together with the brake caliper support 6. The caliper seal part 51 in this context is configured as a projecting part (rib) of the brake caliper body 4C and the support seal part 52 is embodied as a projecting part (rib) of the holding section 6D of the brake caliper support 6. Radially viewed, the caliper seal part 51 and the support seal part 52 overlap each other so that in the gap 15 a plurality of deflections 53 are provided. Deflections mean in this context that air which escapes through the gap 15 from the brake caliper device 400 is deflected several times, which has the result that the escape of the air through the gap 15 is made significantly more difficult. The caliper seal part 51 and the support seal part 52 however do not close the gap 15 completely but serve for radial sealing of the gap 15. Due to the seal device 50, a radial escape of brake dust particles through the gap 15 is prevented.

FIG. 12 shows a seal device 60 which can be used as an alternative to the seal device 50. The seal device 60 is also of a two-part configuration and comprises a caliper seal part 61 which is formed as one piece together with the brake caliper 4 and a support seal part 62 which is formed as one piece together with the brake caliper support 6. The caliper seal part 61 is a channel extending along the axial direction AX. The support seal part 62 is embodied as a projecting rib of the holding section 6D of the brake caliper support 6. The rib 62 protrudes in the illustrated mounted state into the channel 61. Viewed radially, the caliper seal part 61 and the support seal part 62 form a plurality of deflections 63 in the gap 15 so that the gap 15 is radially sealed.

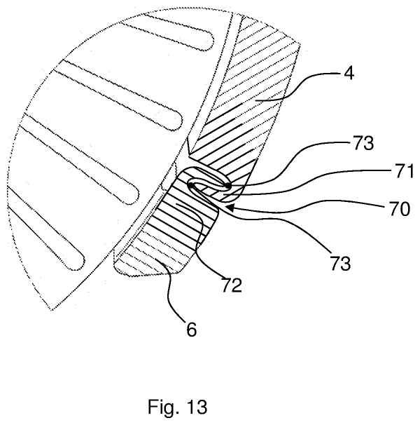

FIG. 13 shows a seal device 70 which can be used as an alternative to the seal device 50, 60. The seal device 70 is also of a two-part configuration and comprises a caliper seal part 71 which is formed as one part together with the brake caliper 4 and a support seal part 72 which is formed as one part together with the brake caliper support 6. The caliper seal part 71 is a rib with a shape which is curved in section and protrudes radially inwardly. The support seal part 72 has a complementary shape and is embodied as a rib which comprises in section a curved shape and protrudes radially outwardly. The caliper seal part 71 and the support seal part 72 protrude in this context into each other such that a labyrinth seal 70 is formed. Due to the seal device 70, a radial escape of particles is reduced because a plurality of deflections 73 are provided in the gap 15.

The embodiments can be modified in multiple ways. In particular, the shape of the seal device 50, 60, 70 can be varied at will as long as it has an axial extension direction AX and enables a radial sealing action. The seal device can be provided, for example, as a separate component which is attached to the brake caliper and/or to the brake caliper support. The seal device can also be embodied, for example, as a brush seal or the like. Instead of the seal device 60 of FIG. 12, the channel 61 could also be part of the brake caliper support 6 and the rib 62 part of the brake caliper 4.

### REFERENCE NUMBERS

1 brake dust particle filter
2 brake disc
2A, 2B brake disc friction surface
2C outflow opening
2D brake disc edge
2E fastening plate
2F fastening opening
3 brake caliper holder
4 brake caliper
4A brake caliper leg
4C brake caliper body
5 brake pad
6 brake caliper support
6A, 6B fastening section
6C, 6D holding section
6E connection arc
6F receiving region
8 brake hydraulics
9 floating support
10 filter housing
11A (outer) sidewall
11B (inner) sidewall
12 (outer) circumferential wall
13A (inner outwardly positioned) circumferential wall section
13B (inner inwardly positioned) circumferential wall section
14 connection contour
15 gap
16 end wall
17 slot
19 fastener
20 housing interior
50 seal device
51 caliper seal part
52 support seal part
53 deflection
60 seal device
61 caliper seal part
62 support seal part
63 deflection
70 seal device
71 caliper seal part
72 support seal part
73 deflection
100 disc brake assembly
400 brake caliper device
500 system
A axis of rotation
AX axial extension direction
CX circumferential extension direction
F forward travel direction
R forward rotation direction
RI inner radius
RO outer radius
RX radial extension direction
Y detail
Z detail

1. A brake caliper device for a disc brake assembly with a brake disc, the brake caliper device comprising:
a brake caliper support configured to be arranged stationarily relative to a vehicle;
a brake caliper configured to hold at least one brake pad, and to slide relative to the brake caliper support in an axial direction; and
a seal device configured to seal a gap formed between the brake caliper and the brake caliper support,
wherein the seal device extends in the axial direction, and
wherein the seal device comprises a brush, a sealing lip, and/or a loose sealing material projecting away from the brake caliper support in a direction toward the oppositely positioned brake caliper and/or projecting away from the brake caliper in a direction toward the oppositely positioned brake caliper support.

2. The brake caliper device according to claim 1, wherein the brake caliper support comprises:
at least two fastening sections configured to connect the brake caliper support to a steering knuckle of the vehicle; and
a holding section extending from the at least two fastening sections in the axial direction, wherein the holding section, in a mounted state of the brake caliper device, at least partially surrounds the brake disc and comprises a receiving region for the brake caliper,
wherein the brake caliper comprises:
two brake caliper legs configured to fasten the at least one brake pad, respectively; and
a brake caliper body connecting the brake caliper legs to each other and at least partially surrounding the brake disc in the mounted state of the brake caliper device, and
wherein the gap sealed by the seal device is a gap formed between the holding section of the brake caliper support and the brake caliper body of the brake caliper.

3. The brake caliper device according to claim 1, wherein the seal device is configured to reduce a particle escape in a radial direction in relation to a rotation direction of the brake disc in the mounted state of the brake caliper device.

4. The brake caliper device according to claim 1, wherein the seal device comprises a caliper seal part disposed at the brake caliper, and an oppositely positioned support seal part disposed at the brake caliper support.

5. The brake caliper device according to claim 4, wherein the caliper seal part and the support seal part are arranged displaced relative to each other in a radial direction and at least partially overlap each other in a circumferential direction of the brake disc.

6. The brake caliper device according to claim 5, wherein the caliper seal part and the support seal part have mutually complementary and mutually engaging shapes,
wherein the mutually complementary and mutually engaging shapes together form a labyrinth seal comprising a plurality of deflections in the gap along the radial direction, and
wherein the brush, the sealing lip and/or the loose sealing material is present at the caliper seal part or at the support seal part.

7. The brake caliper device according to claim 4, wherein the caliper seal part comprises a guide channel extending along the axial direction
wherein the support seal part comprises a projecting rib protruding into the guide channel, and
wherein the brush, the sealing lip and/or the loose sealing material is present at the projecting rib.

8. The brake caliper device according to claim 4, wherein the support seal part comprises a guide channel extending along the axial direction,
wherein the caliper seal part comprises a projecting rib protruding into the guide channel, and
wherein the brush, the sealing lip and/or the loose sealing material is present at the projecting rib.

9. The brake caliper device according to claim 4, wherein the caliper seal part is formed as one part together with the brake caliper, and/or
wherein the support seal part is formed as one part together with the brake caliper support.

10. The brake caliper device according to claim 4, wherein the caliper seal part is connected detachably to the brake caliper, and/or
wherein the support seal part is connected detachably to the brake caliper support.

11. A disc brake assembly comprising:
a brake disc; and
a brake caliper device comprising:
a brake caliper support configured to be arranged stationarily relative to a vehicle;
a brake caliper configured to slide relative to the brake caliper support in an axial direction;
at least one brake pad held at the brake caliper and configured to be pressed, by a movement of the brake caliper relative to the brake caliper support along the axial direction, against the brake disc; and
a seal device configured to seal a gap formed between the brake caliper and the brake caliper support,
wherein the seal device extends in the axial direction, and
wherein the seal device comprises a brush, a sealing lip, and/or a loose sealing material projecting away from the brake caliper support in a direction toward the oppositely positioned brake caliper and/or projecting away from the brake caliper in a direction toward the oppositely positioned brake caliper support.

12. The disc brake assembly according to claim 11, wherein the seal device is configured to reduce a radial escape of brake dust-laden air, flowing along the brake disc when the brake disc is rotating, from the brake caliper device.

13. A system comprising:
a disc brake assembly according to claim 11; and
a brake dust particle filter,
wherein the brake dust particle filter is arranged downstream of the brake caliper device in a predetermined rotation direction of the brake disc.

14. The system according to claim 13, wherein the predetermined rotation direction is a forward rotation direction.

15. A method comprising:
using the brake caliper device according to claim 1 to radially retain in the brake caliper device brake dust-laden air flowing along the brake disc when the brake disc is rotating.

16. A method for radial retention of brake dust-laden air, flowing along a brake disc when the brake disc is rotating, with the brake caliper device according to claim 1, the method comprising:
preventing by the seal device the brake dust-laden air from escaping radially from the brake caliper device.

17. The method according to claim 16, further comprising introducing the brake dust-laden air into a brake dust particle filter arranged downstream of the brake caliper support in a predetermined rotation direction of the brake disc.

18. The method according to claim 17, further comprising selecting the predetermined rotation direction to be a forward rotation direction.
